(19) United States
(12) Patent Application Publication
(10) Pub. No.: US 2011/0210520 A1
(43) Pub. Date: Sep. 1, 2011

(54) RECIPROCATING SHAFT'S SEALING DEVICE WITH BOTH MAGNETIC FLUID SEAL AND C-TYPE SLIP RING SEAL

(75) Inventors: Decai Li, Beihing (CN); Jishang Wang, Beijing (CN)

(73) Assignee: Beijing Jiaotong University

(21) Appl. No.: 13/033,703

(22) Filed: Feb. 24, 2011

(30) Foreign Application Priority Data
Mar. 1, 2010 (CN) 201010115793.3

(51) Int. Cl. F16J 15/53

(52) U.S. Cl. 277/501

(57) ABSTRACT

A combined sealing device composed of a magnetic fluid seal and a C-type slip ring seal for a reciprocating shaft, characterized in that an internal circlip (2) with an O-shaped rubber seal ring, N pieces of seal assemblies, a C-type slip ring (7) provided on the external circlip, and an external circlip (8) with an O-shaped rubber seal are placed at the end of the sealed chamber (1) with an O-shaped rubber seal in order, and by connecting the external thread of the swivel nut (9) with the thread of the sealed chamber (1) with the O-shaped rubber seal, the swivel nut (9) is adapted to press above listed parts tightly, 1≦N≦20; every seal assembly is composed of a C-type slip ring (3), a pole piece (4) with an O-shaped rubber seal, a permanent magnet (5), and a pole piece (6), then the above-mentioned components are bonded together; before the combined sealing device composed of the magnetic fluid seal and the C-type slip ring for the reciprocating shaft is installed on the shaft, the magnetic fluid is injected into the inner circumferential surface of the permanent magnet of N pieces of seal assemblies. This device can overcome the problem of leakage of the reciprocating compressors.

### FIELD OF THE PRESENT INVENTION

The present invention is related to the field of sealing in mechanical engineering, especially to a reciprocating motion sealing for shaft of vacuum coating machines, compressors and so on when the temperature is below 150° C. and the sealing medium is a gas.

### BACKGROUND OF THE PRESENT INVENTION

A compressor is a general machinery which is used to compress gases to increase pressure or transport gases. The most widely used compressor is type of reciprocating, screwing, and centrifugal. The reciprocating compressor has such advantages as high efficiency and high pressure, so it can be widely used in mining, metallurgy, petroleum, chemical industry and so on. However, the leakage of the reciprocating compressor is a common phenomenon, and because of its wide range of applications, the problem becomes more important to be solved. Especially for compressing or transporting flammable, explosive, poisonous gases, the leakage of the reciprocating compressor cannot be ignored. Current sealing methods of the reciprocating compressor's piston rod are with a packing seal or a labyrinth seal. The packing seal is a contact seal, when the pressure is high, the compressor is easy to wear and low in using life; when the pressure is low, because of insufficient back pressure, the leakage of compressor is high. The labyrinth piston compressor demands very high precision on the manufacture, only a few companies in the world can produce it. Using the response characteristics of magnetic fluid on the magnetic field, the magnetic fluid is injected into the gap between the pole piece and the reciprocating shaft, then liquid O-shaped sealing rings are formed on the surface of the shaft, thus playing a role in sealing. This kind of sealing method demands less precision on the surface of the shaft, and there is no contact between pole piece and the shaft, so the heat productivity is small. But the reciprocating motion of shaft takes away some magnetic fluid, and long time reciprocating motion makes the sealing fail as the amount of magnetic fluid in the sealing gap is reduced. So any single seal structures cannot solve the problem of leakage of reciprocating compressors.

### SUMMARY OF THE PRESENT INVENTION

The object of the present invention is to provide a combined sealing device composed of a magnetic fluid seal and C-type slip ring seal for a reciprocating shaft, so as to solve the problem of leakage of reciprocating compressors when any single sealing cannot meet the sealing requirements currently.

Technical solution of the invention is as follow.

A combined sealing device composed of a magnetic fluid seal and a C-type slip ring for a reciprocating shaft, characterized in that an internal circlip with an O-shaped rubber seal, N pieces of seal assemblies, a C-type slip ring provided on the external circlip, and an external circlip with an O-shaped rubber seal are placed at the end of a sealed chamber with an O-shaped rubber seal in order, and by connecting the external thread of the swivel nut with the thread of the sealed chamber with the O-shaped rubber seal, the swivel nut is adapted to press above listed parts tightly; 1<N<20.

Each seal assembly is composed of a C-type slip ring, a pole piece with an O-shaped rubber seal, a permanent magnet, and a pole piece; and a piece of seal assembly is formed by bonding the above-mentioned components together.

Before the combined sealing device composed of a magnetic fluid seal and a C-type slip ring for a reciprocating shaft is installed on the shaft, and a magnetic fluid is injected into the inner circumferential surface of the permanent magnet of N pieces of seal assemblies.

The pressure endurance of each seal assembly is 0.4 atmospheric pressure, and the number N of seal assembly is determined by seal pressure capability, N>[required pressure endurance/0.4].

In the parameters of tooth profile of the pole piece with the O-shaped rubber seal and the pole piece, the face width is 0.2 mm, the width of the alveolar is 2.5 mm, and the alveolus dip angle between the outer edge generatrix of the pole teeth and the tilt part of the alveolus is 4°.

The carrier fluid of the magnetic fluid is kerosene, and the diameter of magnetic particle is less than 5 nm.

The chamfer of the right side of Gewindefreistiche of the sealed chamber with the O-shaped rubber seal intersected with its lumen is 20°, and the surface roughness Ra is 1.6.

With the beneficial effects of the invention, the combined sealing device composed of the magnetic fluid seal and the C-type slip ring for the reciprocating shaft can overcome the problem of leakage of reciprocating compressors. The C-type slip ring of the device is to prevent the magnetic fluid from being carried away and to prevent the deformation of reciprocating shaft, in which the magnetic fluid seal also plays the important role of seal pressure endurance, so the lifetime of this device is long and the surface temperature of shaft is low.

### BRIEF DESCRIPTION OF THE ACCOMPANYING DRAWINGS

FIG. 1 is a structural view of the combined sealing device composed of a magnetic fluid seal and a C-type slip ring seal for a reciprocating shaft when N is 1.

FIG. 2 is a structural view of the combined sealing device composed of a magnetic fluid seal and a C-type slip ring seal for a reciprocating shaft when N is 8.

FIG. 3 is a structural view of the combined sealing device composed of a magnetic fluid seal and a C-type slip ring seal for a reciprocating shaft when N is 20.

FIG. 4 is a sectional view of the swivel nut.

FIG. 5 is a sectional view of the sealed chamber.

FIG. 6 is a sectional view of the pole piece.

FIG. 7 is a view of partial enlargement of the device.

FIG. 8 is a sectional view of the pole piece with an O-shaped rubber seal.

FIG. 9 is a sectional view of the internal circlip.

FIG. 10 is a sectional view of the external circlip with an O-shaped rubber seal.

In the figures, there are shown a sealed chamber 1 with an O-shaped rubber seal, an internal circlip 2 with an O-shaped rubber seal, a C-type slip ring 3 with an O-shaped rubber seal, a pole piece 4 with an O-shaped rubber seal, a permanent magnet 5, a pole piece 6, a C-type slip ring 7 on an external circlip, an external circlip 8 with an O-shaped rubber seal, a swivel nut 9, and seal assemblies 101 to 120.

### PREFERRED EMBODIMENTS TO CARRY OUT THE PRESENT INVENTION

A further explanation of embodiments of this invention is made with the attached drawings.

### Mode 1

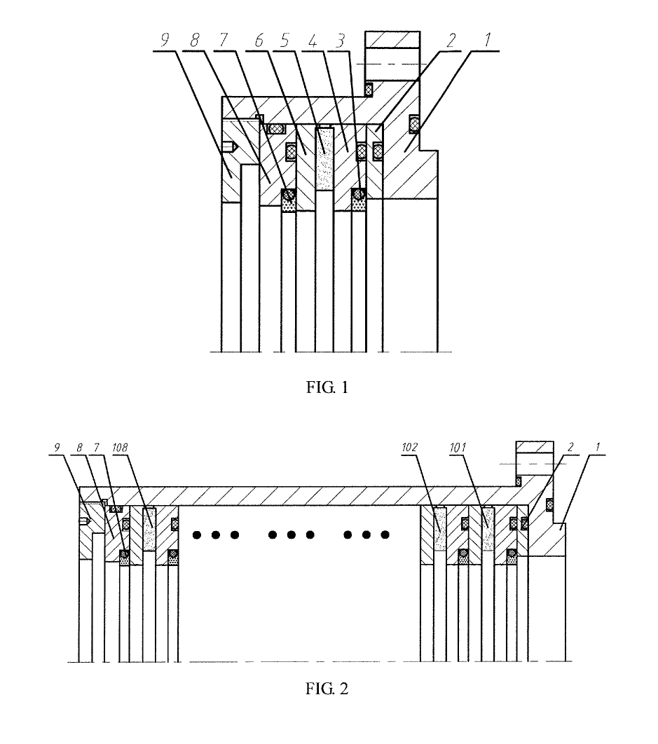

As shown in the FIG. 1, a combined sealing device composed of a magnetic fluid seal and a C-type slip ring for a reciprocating shaft is characterized in that the internal circlip 2 with an O-shaped rubber seal, the seal assembly 101, the C-type slip ring 7 provided on the external circlip, the external circlip 8 with an O-shaped rubber seal are placed at the end of a sealed chamber 1 with an O-shaped rubber seal in order, and by connecting external thread of the swivel nut 9 with the thread of sealed chamber 1 with the O-shaped rubber seal, the swivel nut 9 is made to press above listed parts tightly.

The seal assembly 101 is composed of a C-type slip ring 3, a pole piece 4 with an O-shaped rubber seal, a permanent magnet 5, and pole piece 6, and a piece of seal assembly is formed by bonding the above-mentioned components together.

Before the combined sealing device composed of the magnetic fluid seal and the C-type slip ring for the reciprocating shaft is installed on the shaft, the magnetic fluid is injected into the inner circumferential surface of the permanent magnet 5 of the seal assembly 101.

### Mode 2

As shown in the FIG. 2, the combined sealing device composed of the magnetic fluid seal and the C-type slip ring for the reciprocating shaft is characterized in that the internal circlip 2 with the O-shaped rubber seal, the seal assemblies 101 to 108, the C-type slip ring 7 on the external circlip, the external circlip 8 with the O-shaped rubber seal are placed at the end of the sealed chamber 1 with the O-shaped rubber seal in order, and by connecting external thread of the swivel nut 9 with the thread of sealed chamber 1 with the O-shaped rubber seal, the swivel nut 9 is made to press above listed parts tightly.

There are 8 pieces of the seal assemblies 101 to 108, and the structure and the size of every seal assembly are the same as the seal assembly mentioned in the Mode 1 of carrying out the invention.

Before the combined sealing device composed of the magnetic fluid seal and the C-type slip ring for the reciprocating shaft is installed on the shaft, the magnetic fluid is injected into the inner circumferential surface of the permanent magnet 5 of the seal assemblies 101 to 108.

### Mode 3

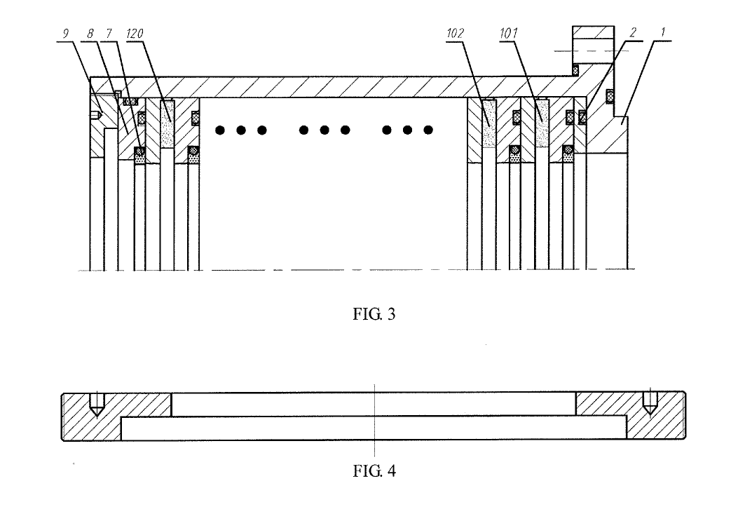

As shown in the FIG. 3, the Mode 3 and the Mode 2 of carrying out the invention are distinguished by their numbers of seal assemblies, there are 20 pieces of seal assemblies in the Mode 3.

Before the combined sealing device composed of the magnetic fluid seal and the C-type slip ring for the reciprocating shaft is installed on the shaft, the magnetic fluid is injected into the inner circumferential surface of the permanent magnet 5 of the seal assemblies 101 to 120.

The pressure endurance of each seal assembly is about 0.4 atmospheric pressure, and the number N of seal assembly is determined by seal pressure capability, N>[required pressure endurance/0.4].

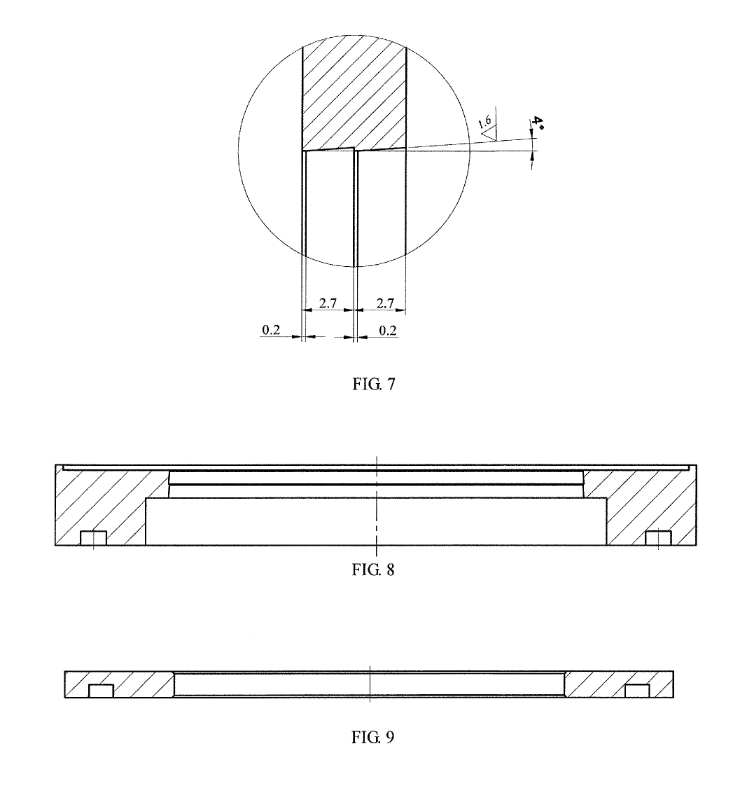

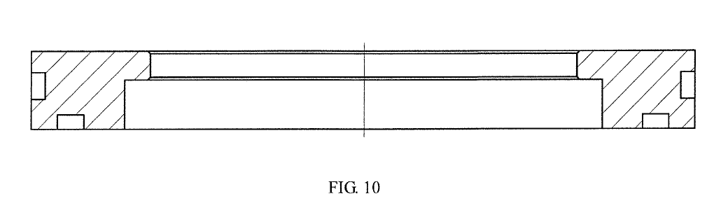

As shown in FIG. 7, in the parameters of tooth form of the pole piece 4 with the O-shaped rubber seal and the pole piece 6, the face width is 0.2 mm, the width of the alveolar is 2.5 mm, the alveolus dip angle between the outer edge generatrix of the pole teeth and the tilt part of the alveolus is 4°.

The carrier fluid of the magnetic fluid is kerosene, and the diameter of the magnetic particle is less than 5 nm.

As shown in FIG. 5, the chamfer of the right side of Gewindefreistiche of the sealed chamber 1 with the O-shaped rubber seal intersected with its lumen is 20°, and the surface roughness Ra is 1.6.

As shown in the FIGS. 1, 2, 3, and 5, the two sides of the flanges of the sealed chamber 1 with the O-shaped rubber seal are designed to have a seal groove in which the O-shaped rubber seal are placed. Thread is provided on interior surfaces of the sealed chamber 1 with the O-shaped rubber seal, which is used to connect with the internal circlip 2 with the O-shaped rubber seal; the chamfer of the right side of Gewindefreistiche intersected with its lumen is 20°, and the surface roughness Ra is 1.6, The aim is to avoid damaging the O-shaped rubber seal during installing circlip. Four through-holes are laid out evenly on the flange of the sealed chamber 1 with the O-shaped rubber seal, which are used to connect with the internal face of the seal cavity.

As shown in FIG. 4, thread is provided on the exterior circumferential surfaces of the swivel nut 9, which is used to connect with the sealed chamber with the O-shaped rubber seal; four through-holes are manufactured evenly on the right surface of the sealed chamber so that the swivel nut 9 can be easily installed and removed.

The structure and size of seal assemblies are the same as one another.

As shown in FIG. 8, the right end face of the pole piece 4 with the O-shaped rubber seal is designed to have one seal groove in which the O-shaped rubber seal is placed, and the pole teeth are machined in the annulus of the small inner-bore.

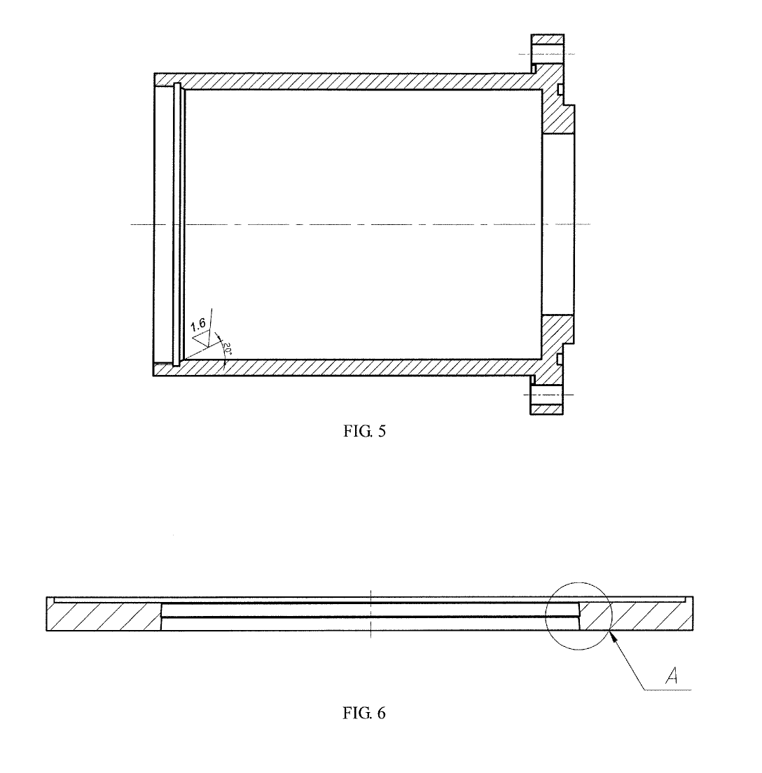

As shown in FIG. 6, the tooth of the pole piece 6 is machined in the annulus of the inner-bore.

As shown in FIG. 10, the right end face and the exterior cylindrical surface of the external circlip 8 with the O-shaped rubber seal is designed to have a seal groove in which the O-shaped rubber seal is placed.

All the O-shaped seals are made of Viton; the material of the permanent magnet is Nd—Fe—B; and the material of the pole piece 4 with the O-shaped rubber seal and the pole piece 6 is DT3.

As an example, the sealing device of the invention is used to seal the reciprocating shaft whose diameter is 80 mm Each pole piece has 2 teeth, and the thickness of the seal gap is 0.2 mm, the width of the alveolar is 2.5 mm, the number of seal assembly is N=8, the material of the permanent magnet is Nd—Fe—B, the material of the C-type slip ring is PTFE, a kerosene-base magnetic fluid is adopted. The effect of seal is quite obvious when the stroke of the reciprocating shaft is 280 mm, and the running speed of the crank is 192 r/min.

1. A combined sealing device composed of a magnetic fluid seal and a C-type slip ring seal for a reciprocating shaft, characterized in that an internal circlip (2) with an O-shaped rubber seal, N pieces of seal assemblies, a C-type slip ring (7) provided on the external circlip, and an external circlip (8) with an O-shaped rubber seal are placed at the end of a sealed chamber (1) with an O-shaped rubber seal in order, and by connecting the external thread of the swivel nut (9) with the thread of the sealed chamber (1) with the O-shaped rubber seal, the swivel nut (9) is adapted to press above listed parts tightly; 1≦N≦20,
each seal assembly is composed of a C-type slip ring (3), a pole piece (4) with an O-shaped rubber seal, a permanent magnet (5), and a pole piece (6), and a piece of seal assembly is formed by bonding the above-mentioned components together, and
before the combined sealing device composed of the magnetic fluid seal and the C-type slip ring for the reciprocating shaft is installed on the shaft, a magnetic fluid is injected into the inner circumferential surface of the permanent magnet (5) of the N pieces of seal assemblies.

2. A combined sealing device composed of a magnetic fluid seal and a C-type slip ring seal for a reciprocating shaft according to claim 1, characterized in that the pressure endurance of each seal assembly is 0.4 atmospheric pressure, and the number N of the seal assembly is determined by seal pressure capability, N>[required pressure endurance/0.4].

3. A combined sealing device composed of a magnetic fluid seal and a C-type slip ring seal for a reciprocating shaft according to claim 1, characterized in that in the parameters of tooth profile of the pole piece (4) with the O-shaped rubber seal and the pole piece (6), the face width is 0.2 mm, the width of the alveolar is 2.5 mm, and the alveolus dip angle between the outer edge generatrix of the pole teeth and the tilt part of the alveolus is 4°.

4. A combined sealing device composed of a magnetic fluid seal and a C-type slip ring seal for a reciprocating shaft according to claim 1, characterized in that the carrier fluid of the magnetic fluid is kerosene, and the diameter of the magnetic particle is less than 5 nm.

5. A combined sealing device composed of a magnetic fluid seal and a C-type slip ring seal for a reciprocating shaft according to claim 1, characterized in that the chamfer of the right side of Gewindefreistiche of the sealed chamber (1) with the O-shaped rubber seal ring intersected with its lumen is 20°, and the surface roughness Ra is 1.6.
